(19) United States
(12) Patent Application Publication
(10) Pub. No.: US 2016/0124519 A1
(43) Pub. Date: May 5, 2016

(54) INSTRUCTION RECEIVING SYSTEM, METHOD, AND RECORDING MEDIUM

(71) Applicant: TOYOTA JIDOSHA KABUSHIKI KAISHA, Toyota-shi (JP)

(72) Inventors: Kazuhiro KAMIYA, Okazaki-shi (JP); Hiroyasu KATO, Okazaki-shi (JP); Seiichi TANAKA, Toyota-shi (JP)

(21) Appl. No.: 14/932,246

(22) Filed: Nov. 4, 2015

(30) Foreign Application Priority Data
Nov. 5, 2014 (JP) 2014-224880

(51) Int. Cl. G06F 3/038; G06F 3/0481

(52) U.S. Cl. CPC G06F 3/038; G06F 3/04812

(57) ABSTRACT

An instruction receiving system includes: an arrangement determination portion configured to determine an arrangement of a display region on a display portion; a display controlling portion configured to display a user interface screen on the display region; a pointer display portion configured to display a pointer on the display portion based on an output value of a pointing device, wherein when the arrangement is changed, the pointer display portion determines a range of the display portion based on the arrangement thus changed, the range of the display portion corresponding to a range of the output value of the pointing device.

### INCORPORATION BY REFERENCE

The disclosure of Japanese Patent Application No. 2014-224880 filed on Nov. 5, 2014 including the specification, drawings and abstract is incorporated herein by reference in its entirety.

### BACKGROUND OF THE INVENTION

1. Field of the Invention

The present invention relates to an instruction receiving system, a method, and a recording medium.

2. Description of Related Art

There has been known a configuration in which a pointer and icons are displayed on a user interface screen and an icon is selected by operating the pointer by a pointing device. For example, Japanese Patent Application Publication No. 2006-134184 (JP 2006-134184 A) describes a configuration in which two-dimensional plane coordinates on an input panel are associated with screen coordinates on a monitor so as to correspond to each other (JP 2006-134184 A).

### SUMMARY OF THE INVENTION

However, when an arrangement of a display region on the user interface screen is changed, operationability of the pointing device is changed remarkably. That is, since coordinates specified by the pointing device correspond to coordinates on the screen on a one-to-one basis, even if the arrangement of the display region is changed, a correspondence between the coordinates specified by the pointing device and the coordinates on the screen is not changed. On this account, when a state where a whole display portion serves as a display region is changed to a state where part of the display portion serves as the display region, for example, coordinates within the display region can be specified only by part of a range of coordinates that can be specified by the pointing device. Accordingly, a state where coordinates within the display region are specified by the pointing device coexists with a state where coordinates are not specified, but it is difficult for a user to recognize this state change, thereby resulting in that operationability of the pointing device is decreased. The present invention provides a technique to prevent a decrease in operationability of a pointing device.

A first aspect of the present invention relates to an instruction receiving system. The instruction receiving system includes: an arrangement determination portion configured to determine an arrangement of a display region on a display portion; a display controlling portion configured to display a user interface screen on the display region; a pointer display portion configured to display a pointer on the display portion based on an output value of a pointing device, wherein when the arrangement is changed, the pointer display portion determines a range of the display portion based on the arrangement thus changed, the range of the display portion corresponding to a range of the output value of the pointing device.

A second aspect of the present invention relates to an instruction receiving method. The instruction receiving method includes: (a) determining an arrangement of a display region on a display portion; (b) displaying a user interface screen on the display region; and (c) displaying a pointer on the display portion based on an output value of a pointing device, wherein in step (c), when the arrangement is changed, a range of the display portion based on the arrangement thus changed, the range of the display portion corresponding to a range of the output value of the pointing device.

A third aspect of the present invention relates to a recording medium in which an instruction receiving program is stored and from which the instruction receiving program is readable by a computer. The instruction receiving program includes: an arrangement determination function to cause a computer to implement a function to determine an arrangement of a display region on a display portion; a display controlling function to cause the computer to implement a function to display a user interface screen on the display region; a pointer display function to cause the computer to implement a function to display a pointer on the display portion based on an output value of a pointing device, when the arrangement is changed, the pointer display function causes the computer to implement a function to determine a range of the display portion based on the arrangement thus changed, the range of the display portion corresponding to a range of the output value of the pointing device.

That is, when the arrangement of the display region on the display portion is changed, that range of the display portion which corresponds to the range of the output value of the pointing device is determined based on the arrangement thus changed. Accordingly, even if the arrangement of the display region arrangement is changed in any way, the correspondence between the range of the output value of the pointing device and the range of the display portion can be changed according to the arrangement thus changed. This accordingly allows the correspondence to be suitable for the arrangement of the display region, so that operationability of the pointing device is hard to decrease.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram illustrating an instruction receiving system;

FIG. 2A is a view illustrating an example of a user interface screen;

FIG. 2B is a view illustrating an example of a user interface screen;

FIG. 2C is a view illustrating an example of a user interface screen; and

FIG. 3 is a flowchart illustrating a pointer display process.

### DETAILED DESCRIPTION OF EMBODIMENTS

Hereinafter described is an embodiment of the present invention according to the following order:
(1) Configuration of Instruction Receiving System:
(2) Pointer Display Process:
(3) Other Embodiments:

### (1) Configuration of Instruction Receiving System

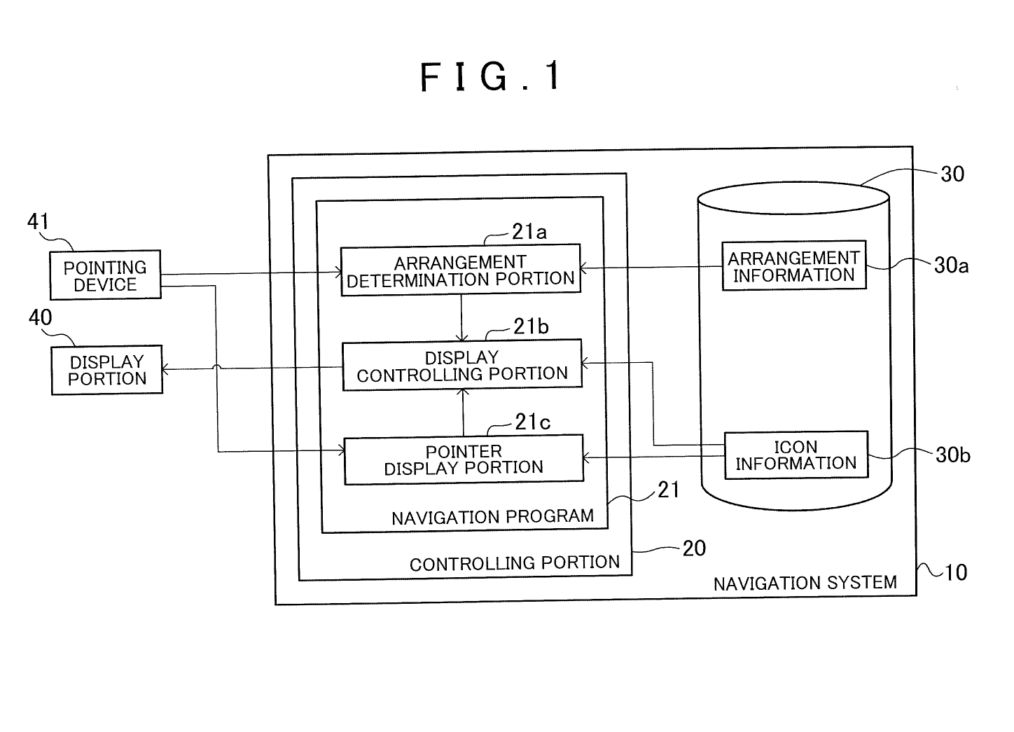

FIG. 1 is a block diagram illustrating a configuration of a navigation system 10 that implements an instruction receiving system according to one embodiment of the present invention. The instruction receiving system according to the present embodiment is implemented as one function of the navigation system 10 provided in a vehicle. The navigation system 10 includes a controlling portion 20 including a CPU, a RAM, a ROM, and so on, and the controlling portion 20 can perform a desired program stored in the ROM or a recording medium 30. In the present embodiment, the controlling portion 20 can perform a navigation program 21, and by performing the navigation program 21, the controlling portion 20 guides the vehicle provided with the navigation system 10 to a designated destination based on a GPS signal or the like (not shown). Further, the navigation program 21 can cause the controlling portion 20 to perform various processes as well as a process for guidance, and includes a function to perform a process for audio play as one of the various processes, in the present embodiment. For example, the controlling portion 20 can acquire music data stored in the recording medium 30 by a process of the navigation program 21 and output music from a speaker (not shown).

Moreover, the vehicle includes a pointing device 41 and a display portion 40 that can be used at the time when input and output for the guidance are performed. The display portion 40 is connected to the controlling portion 20 via an interface (not shown), and the controlling portion 20 can display a given image on the display portion 40 by specifying given coordinates by outputting a control signal to the display portion 40. In the present embodiment, the controlling portion 20 displays, on the display portion 40, a user interface screen for using various functions. In the present embodiment, the user interface screen includes icons and a pointer for pointing an icon or the like.

The pointing device 41 includes a lever, and is connected to the controlling portion 20 via an interface (not shown). When a user operates the lever of the pointing device 41, the pointing device 41 outputs a signal according to an operation content of the lever. The controlling portion 20 acquires the signal, and specifies the operation content of the user. That is, the controlling portion 20 acquires a display position of the pointer displayed on the user interface screen based on the output of the pointing device 41, and the controlling portion 20 changes the display position of the pointer, following a change of the display position. On this account, the user can perform an input for selecting an icon on the user interface screen by operating the pointing device 41 to move the pointer. Note that, in the present embodiment, the pointing device 41 can output two types of output values corresponding to two coordinate axes, and can specify two-dimensional coordinates by the two types of output values. Further, a range of the output values is determined in advance, and the range is from 0 to 255 for each coordinate axis.

In the present embodiment, various functions are implemented by the user interface screen. However, display contents to be displayed on a user interface screen are different between respective functions, so that an arrangement of the display region may be different on a user interface screen for each function. As such, in a configuration in which the arrangement of the display region on the user interface screen can be changed, if such a state in which coordinates to be specified by the pointing device correspond to coordinates on the screen on a one-to-one basis is maintained, operationability of the pointing device is changed remarkably.

In view of this, in the present embodiment, a configuration to prevent a decrease in the operationability of the pointing device is employed. In order to provide user interface screens having different arrangements of the display region while restraining the decrease of the operationability, the navigation program 21 includes an arrangement determination portion 21a, a display controlling portion 21b, and a pointer display portion 21c.

The arrangement determination portion 21a is a program module for causing the controlling portion 20 to implement a function to determine an arrangement of the display region on the display portion. That is, the display region of the user interface screen to be displayed on the display portion 40 changes according to various triggers. Accordingly, when a trigger occurs, the controlling portion 20 specifies a user interface screen to be displayed according to the trigger by a process of the arrangement determination portion 21a, and determines an arrangement of the display region on which to display the user interface screen. The arrangement of the display region is defined as arrangement information 30a in advance and stored in the recording medium 30. Accordingly, when a trigger to change the arrangement of the display region for the user interface screen occurs, the controlling portion 20 refers to the arrangement information 30a and determines the arrangement of the display region.

Here, such a state is assumed that the following user interface screens are changed to each other: a user interface screen to select an option such as a search result of a destination; a user interface screen on which to display only a map to perform guidance; and a user interface screen on which to display the map to perform guidance and an operation screen to perform audio play. That is, when the user performs an operation to display each user interface screen by the pointing device 41 or the like, a trigger to display the each user interface screen occurs.

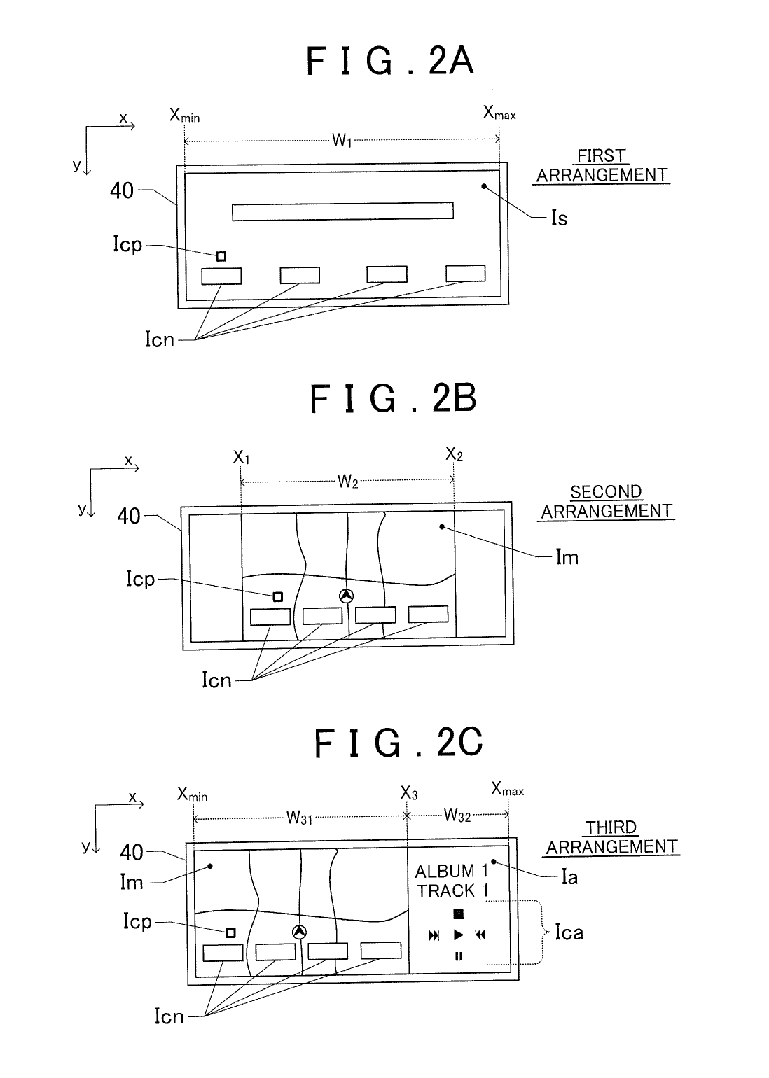

In the present specification, the user interface screen to select an option such as a search result of a destination is a screen having one display region in which a whole width of the display portion 40 (a length of the display portion 40 in a right-left direction) serves as a width of the display region, and this arrangement of the display region is referred to as a first arrangement. Note that, FIG. 2A is a view illustrating a state where a user interface screen Is is displayed on the display portion 40 with the first arrangement. The user interface screen on which to display only the map to perform guidance is a screen having one display region in which a partial width of the display portion 40 serves as a width of the display region, and this arrangement of the display region is referred to as a second arrangement. Note that FIG. 2B is a view illustrating a state where a user interface screen Im is displayed on the display portion 40 with the second arrangement. As illustrated in FIG. 2B, in the second arrangement, a full width of the user interface screen Im is narrower than a full width of the display portion 40, and regions where the user interface screen is not displayed exist in right and left regions. On the user interface screen on which to display the map to perform guidance and the operation screen to perform audio play, a first range within the width of the display portion 40 serves as a width of a first display region for displaying the map, and a second range, which is a remaining range of the width of the display portion 40, serves as a width of a second display region. Such an arrangement of the display regions is referred to as a third arrangement. Note that FIG. 2C is a view illustrating a state where user interface screens Im, Ia are displayed on the display portion 40 with the third arrangement.

The display controlling portion 21b is a program module for causing the controlling portion 20 to implement a function to display a user interface screen on the display region. In the present embodiment, a predetermined storage area is secured in the RAM in order to display a given image to an entire display region of the display portion 40. The controlling portion 20 generates information to display a given user interface screen on a display region determined by the process of the arrangement determination portion 21a, and writes the information to be displayed on the display region into the RAM. In the present embodiment, a map and icons can be displayed on the user interface screen. An image showing the map is generated by the controlling portion 20 based on map information (not shown).

Images showing the icons are defined in advance as icon information 30b. The controlling portion 20 refers to the icon information 30b, so as to acquire an image of an icon to be displayed on each user interface screen, and then stores the image of the icon in the RAM so that the image of the icon is placed at a given position. When the controlling portion 20 outputs information of the RAM to the display portion 40, the display portion 40 displays a given user interface screen on each display region with an arrangement determined by the process of the arrangement determination portion 21a.

The pointer display portion 21c is a program module for causing the controlling portion 20 to implement a function to display a pointer on the display portion 40 based on an output value of the pointing device 41. That is, the controlling portion 20 acquires the output value of the pointing device 41, and determines a display position of the pointer based on the output value. In the present embodiment, an image showing the pointer is also defined in advance as icon information 30b. In view of this, the controlling portion 20 acquires information indicative of the image of the pointer from the icon information 30b, and writes, into the RAM, the information to display the image of the pointer on the display region. Accordingly, when the controlling portion 20 outputs information of the RAM to the display portion 40 by the process of the display controlling portion 21b, the pointer is displayed on the display portion 40 at a display position specified by the pointing device 41.

In the present embodiment, since the arrangement of the display region changes according to various triggers, when the controlling portion 20 determines a display position of the pointer by the process of the pointer display portion 21c, the controlling portion 20 determines the display position by associating a range of the output value of the pointing device 41 with a range of the display portion 40 according to the arrangement of the display region. That is, the controlling portion 20 selects a correspondence between the range of the output value of the pointing device 41 and the range of the display portion 40 according to a changed arrangement of the display region, and determines a display position from the output value based on the correspondence.

The correspondence can be defined by various techniques, and may be defined so that operationability of the pointing device 41 does not decrease at the time when the arrangement of the display region is changed. In the present embodiment, a width of the display region after its arrangement is changed and the range of the output value of the pointing device 41 is defined as the correspondence. In this configuration, a whole display region is specified by use of a whole range of the output value of the pointing device 41. Accordingly, at the time when the pointing device 41 is operated, such an output value that substantially invalidates the operation (a state where the output value of the pointing device 41 indicates a part outside the display region) does not exist, thereby making it possible to prevent a decrease in operationability of the pointing device 41. Note that that range of the display portion 40 which corresponds to the range of the output value of the pointing device 41 is determined at the time when the arrangement of the display region is changed, but, of course, even before the change, the range of the output value of the pointing device 41 and the range of the display portion 40 have a specific correspondence. For example, the following configuration or the like may be employed: in a case where the arrangement of the display region is an initial arrangement or a default arrangement, that range of the display portion 40 which corresponds to the range of the output value of the pointing device 41 becomes an initial range or a default range.

In the present embodiment, as illustrated in FIGS. 2A to 2C, when the arrangement of the display region is changed, the display region (a size of the display region and the number of display regions) is changed in a width direction of the display portion 40. Accordingly, the controlling portion 20 changes the range of the output value and the range of the display portion 40 in terms of an output value indicative of a position in the width direction out of two types of output values of the pointing device 41. Of course, in a case where the display region is changed in a height direction perpendicular to the width direction, such a configuration may be employed that the range of the output value and the range of the display portion 40 are changed in terms of two types of output values of the pointing device 41.

In the present embodiment, when a changed arrangement of the display region is the first arrangement, the controlling portion 20 associates, by the process of the pointer display portion 21c, a range (0 to 255) of an output value indicative of a position in the width direction, out of two types of output values of the pointing device 41, with a whole width (from a minimum value xmin to a maximum value xmax of an x-coordinate indicative of the position in the width direction) of the display portion 40. As a result, when the user operates to change the position in the width direction by the pointing device 41, a pointer Icp moves with a full width W1 of the display portion 40, as illustrated in FIG. 2A, being taken as a movable range.

In a case where the changed arrangement of the display region is the second arrangement, the controlling portion 20 associates, by the process of the pointer display portion 21c, the range (0 to 255) of the output value indicative of the position in the width direction, out of two types of output values of the pointing device 41, with a partial range (from values x1 to x2 in the x-coordinate indicative of the position in the width direction) of the width of the display portion 40. That is, as illustrated in FIG. 2B, in the second arrangement, since a partial width W2 of the display portion 40 is a display region for the user interface screen Im, the width W2, which is a whole range of the display region in the width direction and which is a partial width of the display portion 40, is associated with the range of the output value indicative of the position in the width direction. As a result, when the user operates to change the position in the width direction by the pointing device 41, the pointer Icp moves with the partial width W2 of the display portion 40, as illustrated in FIG. 2B, being taken as a movable range, and the pointer does not reach right and left regions across the width W2.

In the configuration in which the arrangement the display region can be changed between the first arrangement and the second arrangement like the present embodiment, when the first arrangement is changed to the second arrangement, for example, if the correspondence between the range of the output value of the pointing device 41 and the range of the display portion 40 is not changed, a region outside the width W2 in the second arrangement corresponds to an output value of the pointing device 41. Accordingly, when the pointing device 41 is operated, an output value that substantially invalidates the operation exists, thereby decreasing the operationability of the pointing device 41.

However, in the present embodiment, in a case of the first arrangement, the range of the output value is associated with the whole width W1 of the display portion 40, and in a case of the second arrangement, the range of the output value is associated with the partial width W2 of the display portion 40. Accordingly, in a case where the pointing device 41 is operated both in the first arrangement and the second arrangement, an output value that substantially invalidates the operation does not exist, thereby making it possible to prevent a decrease in the operationability of the pointing device 41.

In a case where the changed arrangement of the display region is the third arrangement and the pointer exists in the first display region, the controlling portion 20 associates, by the process of the pointer display portion 21c, the range (0 to 255) of the output value indicative of the position in the width direction, out of two types of output values of the pointing device 41, with the first range (from the minimum value xmin to a value x3 in the x-coordinate indicative of the position in the width direction). That is, as illustrated in FIG. 2C, in the third arrangement, since a first range W31 of the display portion 40 in the width direction is the first display region for displaying the user interface screen Im, and a second range W32, which is a remaining range of the display portion 40 in the width direction, is the second display region for displaying the user interface screen Ia.

In view of this, in a case where the changed arrangement of the display region is the third arrangement and the pointer exists in the first display region, the controlling portion 20 associates the width W31, which is a whole range of the first display region in the width direction, with the range (0 to 255) of the output value indicative of the position in the width direction. As a result, when the user operates, by the pointing device 41, to change a position, in the width direction, of the pointer that exists in the first display region, the pointer Icp moves with the width W31 of the display portion 40, as illustrated in FIG. 2C, being taken as a movable range.

In a case where the changed arrangement of the display region is the third arrangement and the pointer exists in the second display region, the controlling portion 20 associates, by the process of the pointer display portion 21c, the range (0 to 255) of the output value indicative of the position in the width direction, out of two types of output values of the pointing device 41, with the second range (from the value x3 to the maximum value xmax in the x-coordinate indicative of the position in the width direction). As a result, when the user operates, by the pointing device 41, to change the position, in the width direction, of the pointer that exists in the second display region, the pointer moves with the width W32 of the display portion 40, as illustrated in FIG. 2C, being taken as a movable range.

With the above configuration, in either case where the pointer exists in the first display region or the second display region, an output value that substantially invalidates an operation at the time when the user operates the pointing device 41 does not exist, thereby making it possible to prevent a decrease in the operationability of the pointing device 41. Note that, in the present embodiment, a region with the width W2 in the second arrangement and a region with the width W31 in the third arrangement are a display region for a map, as illustrated in FIGS. 2B, 2C. In the present embodiment, the arrangement of the display region is prescribed so that the width W2 and the width W31 have the same length. With this configuration, even if the arrangement of the display region is changed between the second arrangement and the third arrangement, an operation amount of the pointing device 41 to be operated at the time when the pointer is moved by a unit distance on the map does not change. Accordingly, the operationability does not change due to the change of the display region.

Note that, in the third arrangement, when the pointer exists in a boundary between the first display region and the second display region for a predetermined period of time, the pointer moves from one of the display regions to the other one of the display regions. That is, in a case where the pointer exists in the first display region, when a predetermined period of time elapses in a state where the output value of the pointing device 41 is a maximum value, the controlling portion 20 moves the pointer to the second display region. Further, in a case where the pointer exists in the second display region, when a predetermined period of time elapses in a state where the output value of the pointing device 41 is a minimum value, the controlling portion 20 moves the pointer to the first display region.

### (2) Pointer Display Process

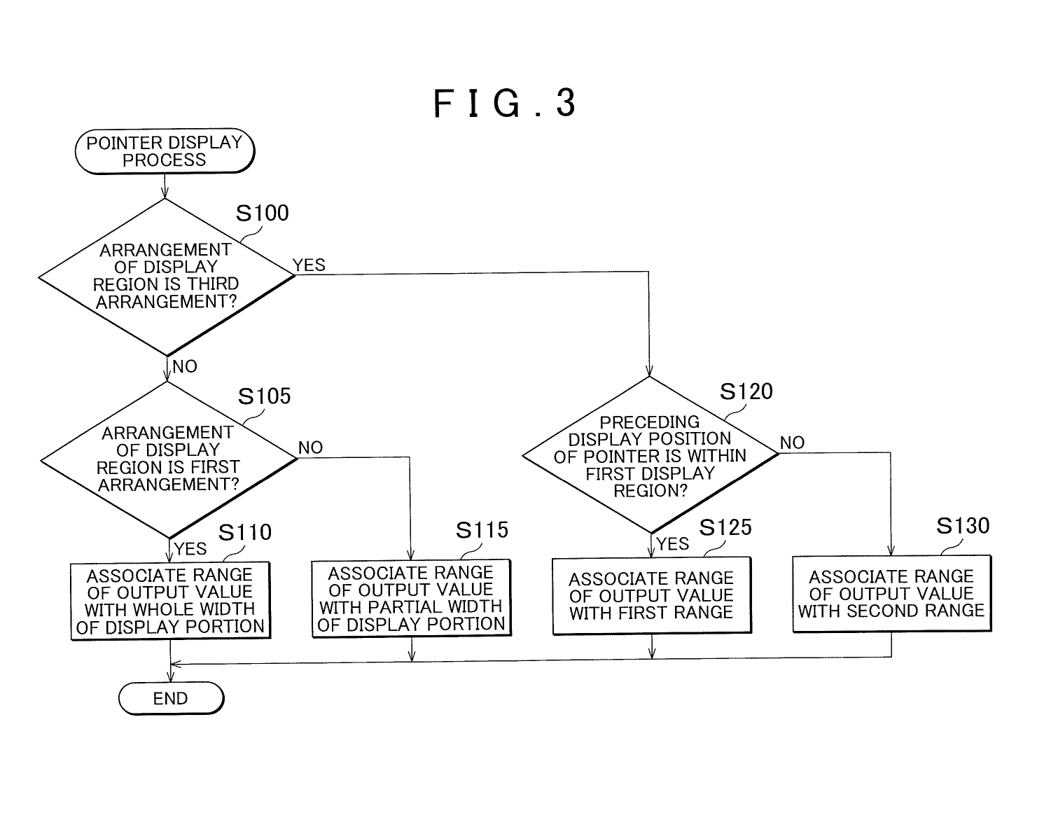

Next will be described the pointer display process in detail. FIG. 3 is a flowchart of the pointer display process. The pointer display process is performed in a case where a trigger to change the arrangement of the display region occurs in a course where the controlling portion 20 displays a user interface screen including the pointer and the icons on the display portion 40 by the processes of the display controlling portion 21b and the pointer display portion 21c.

In the pointer display process, the controlling portion 20 determines whether or not the changed arrangement of the display region is the third arrangement by the process of the pointer display portion 21c (step S100). When it is not determined that the changed arrangement of the display region is the third arrangement in step S100, the controlling portion 20 determines whether or not the changed arrangement of the display region is the first arrangement by the process of the pointer display portion 21c (step S105).

When it is determined that the changed arrangement of the display region is the first arrangement in step S105, the controlling portion 20 associates the range of the output value of the pointing device 41 with the whole width of the display portion 40 by the process of the pointer display portion 21c (step S110). That is, the controlling portion 20 associates the range (0 to 255) of the output value indicative of the position in the width direction, out of two types of output values of the pointing device 41, with the whole width (from the minimum value xmin to the maximum value xmax in the x-coordinate indicative of the position in the width direction) of the display portion 40.

In the meantime, when it is not determined that the changed arrangement of the display region is the first arrangement in step S105, that is, when the arrangement of the display region is the second arrangement, the controlling portion 20 associates the range of the output value of the pointing device 41 with a partial width of the display portion 40 by the process of the pointer display portion 21c (step S115). That is, the controlling portion 20 associates the range (0 to 255) of the output value indicative of the position in the width direction, out of two types of output values of the pointing device 41, with the partial width (from the value x1 to the value x2 in the x coordinate indicative of the position in the width direction (a whole width of a display region displayed in the second arrangement)) of the display portion 40.

In the meantime, when it is determined that the changed arrangement of the display region is the third arrangement in step S 100, the controlling portion 20 determines whether or not a preceding display position of the pointer is within the first display region (step S120). Note that the preceding display position of the pointer can be specified in such a configuration that a log of the display position of the pointer is recorded and the controlling portion 20 refers to the log.

When it is determined that the preceding display position of the pointer is within the first display region in step S120, the controlling portion 20 associates the range of the output value of the pointing device 41 with the first range by the process of the pointer display portion 21c (step S125). That is, the controlling portion 20 associates the range (0 to 255) of the output value indicative of the position in the width direction, out of two types of output values of the pointing device 41, with the first range (from the minimum value xmin to the value x3 in the x-coordinate indicative of the position in the width direction (a whole width of the first display region)).

In the meantime, when it is not determined that the preceding display position of the pointer is within the first display region in step S120, that is, when the preceding display position of the pointer is within the second display region, the controlling portion 20 associates the range of the output value of the pointing device 41 with the second range by the process of the pointer display portion 21c (step S130). That is, the controlling portion 20 associates the range (0 to 255) of the output value indicative of the position in the width direction, out of two types of output values of the pointing device 41, with the second range (from the value x3 to the maximum value xmax in the x-coordinate indicative of the position in the width direction (a whole width of the second display region)).

When the above-mentioned process is performed, at the time when the controlling portion 20 subsequently acquires an output value of the pointing device 41 by the process of the pointer display portion 21c, the controlling portion 20 determines a display position based on a correspondence between the range of the output value and the range of the display portion 40 associated with each other in step S110, S115, S125, S130. As a result, on each user interface screen of the display portion 40, the pointer is displayed at the display position thus determined based on the correspondence

### (3) Other Embodiments

The above embodiment is merely an example to carry out the present invention, and other various embodiments can be employed as long as that range of the display portion which corresponds to the range of the output value of the pointing device is determined based on a changed arrangement at the time when the arrangement is changed. For example, means for constituting the instruction receiving system may be implemented by one device, or may be constituted by two or more devices. In the latter case, for example, such a configuration in which the display controlling portion 21b is implemented by a control unit that controls the display portion 40 can be employed.

Moreover, as the user interface screen, various screens can be assumed as well as the screen for audio play and the screen for the guidance. For example, the present invention may be applied to a configuration in which a screen for a camera that takes images outside the vehicle, or a screen for a portable terminal, a wireless communication system, or the like is displayed on the display portion. Of course, each controlling portion may be provided in a place distanced from the display portion 40, and may be configured such that the controlling portion 20 is partially implemented by a server provided in a place separated therefrom. Of course, each controlling portion may not be provided in the vehicle.

Arrangement determination means may be able to determine an arrangement of a display region arrangement on the display portion. That is, a display region for a user interface screen to be displayed on the display portion can be changed according to various triggers. When such a trigger occurs, the arrangement determination means may specify a user interface screen to be displayed according to the trigger and determine an arrangement of the display region on which to display the user interface screen. The arrangement of the display region may be determined in advance according to the user interface screen to be displayed, and defined as information indicative of a correspondence between the arrangement of the display region and the user interface screen, and the arrangement determination means may determine an arrangement based on the information. The number and the shape of display regions can be determined arbitrarily. Accordingly, the number of display regions may be one or more, and various shapes including rectangle, polygon, and round can be employed as the shape of the display region.

Display controlling means may be able to display a user interface screen on the display region, and display a given user interface screen on the display region an arrangement of which is determined on the display portion. Of course, any display content is displayed on the user interface screen, any number of icons may be included therein, or a part (a black part) where no object is displayed may be included in the display region.

Pointer display means may be able to display the pointer on the display portion based on the output value of the pointing device. That is, the pointer display means may determine a display position of the pointer from the output value of the pointing device and display it on the display portion. The output value may directly indicate the display position of the pointer, or may indicate an instruction position pointed by the pointer. In any case, the display position can be determined based on the output value.

Further, when the arrangement is changed, the pointer display means determines that range of the display portion which corresponds to the range of the output value of the pointing device, based on the arrangement thus changed. Herein, the correspondence between the range of the output value of the pointing device and the range of the display portion can be changed according to the arrangement thus changed. The correspondence can be defined by various techniques, and may be defined so that the operationability of the pointing device does not decrease when the arrangement of the display region is changed.

As an exemplary configuration for this purpose, there is such a configuration in which widths of respective display regions after the arrangement is changed and the range of the output value of the pointing device are associated with each other, for example. In this configuration, a whole display region is specified by use of a whole range of the output value of the pointing device. Accordingly, such an output value that substantially invalidates an operation (a state where the output value of the pointing device indicates a part outside the display region) when the pointing device is operated does not exist, thereby making it possible to prevent a decrease in the operationability of the pointing device. Note that that range of the display portion which corresponds to the range of the output value of the pointing device is determined when the arrangement of the display region is changed. However, of course, before the change, the range of the output value of the pointing device and the range of the display portion have a specific correspondence. For example, the following configuration or the like is employed: in a case where the arrangement of the display region is an initial arrangement or a default arrangement, that range of the display portion which corresponds to the range of the output value of the pointing device becomes an initial range or a default range.

The range of the output value of the pointing device and the range of the display portion may be changed at least in one direction, but may be changed in two or more directions. That is, in a pointing device that can output two or more output values, a correspondence between the range of the display portion and a range of at least one output value may be variable, and a correspondence between the range of the display portion and a range of two or more output values may be variable.

Moreover, in a case where options for the arrangement to be determined by the arrangement determination means includes a first arrangement in which a whole width of the display portion serves as the width of the display region and a second arrangement in which a partial width of the display portion serves as the width of the display region, the pointer display means may be configured such that, when a changed arrangement is the first arrangement, the pointer display means associates the range of the output value with the whole width of the display portion, and when the changed arrangement is the second arrangement, the pointer display means associates the range of the output value with the partial width of the display portion. That is, in a configuration in which the arrangement of the display region can be changed between the first arrangement in which the whole width of the display portion serves as the width of the display region and the second arrangement in which the partial width of the display portion serves as the width of the display region, in a case where the first arrangement is changed to the second arrangement, for example, if the correspondence between the range of the output value of the pointing device and the range of the display portion does not change, the operationability of the pointing device decreases.

However, in a configuration in which, in a case of the first arrangement, the range of the output value is associated with the whole width of the display portion, and in a case of the second arrangement, the range of the output value is associated with the partial width of the display portion, even if the pointing device is operated both in the first arrangement and the second arrangement, an output value that substantially invalidates the operation does not exist, thereby making it possible to prevent a decrease in the operationability of the pointing device. Note that the whole width of the display portion may be substantially a whole width, or a margin may be provided in an end of the display portion. Further, in each of the first arrangement and the second arrangement, the correspondence between the range of the output value and the range of the display portion may be variable or not variable in terms of a height direction perpendicular to the width of the display portion.

Moreover, in a case where the options for the arrangement to be determined by the arrangement determination means includes a third arrangement in which a first range within the width of the display portion serves as a width of a first display region and a second range different from the first range within the width of the display portion serves as a width of a second display region, the pointer display means may be configured such that: when the changed arrangement is the third arrangement and the pointer exists in the first display region, the pointer display means associates the range of the output value with the first range; and when the changed arrangement is the third arrangement and the pointer exists in the second display region, the pointer display means associates the range of the output value with the second range.

That is, when the pointer exists in either of the display regions in the third arrangement in which the first display region and the second display region are displayed on the display portion, the range of the output value is associated with a whole width (the first range or the second range) of a display region where the pointer exists. In this configuration, even in a case where the pointer exists in either the first display region or the second display region, when a user operates the pointing device, an output value that substantially invalidates the operation does not exist, thereby making it possible to prevent a decrease in the operationability of the pointing device. Even here, in each of the first display region and the second display region, the correspondence between the range of the output value and the range of the display portion may be variable or not variable in terms of the height direction perpendicular to the width of the display portion.

Further, the technique to determine that range of the display portion which corresponds to the range of the output value of the pointing device based on a changed arrangement at the time when the arrangement is changed, like the present invention, can be applied to a program or a method that causes a computer to implement such a technique. Further, such a program may be stored in a recording medium readable by a computer. Further, the aforementioned system, program, and method can assume a case where they are implemented as an independent device and a case where they are implemented by a plurality of devices, and includes various embodiments. For example, it is possible to provide a navigation system, a method, and a program that include the aforementioned means. Further, they can be modified appropriately such that some of them are software or some of them are hardware. Further, the invention is established even as a recording medium of a program for controlling the system. Of course, the recording medium of the software may be a magnetic storage medium or an optomagnetic recording medium, and the same can apply to any type of recording media to be developed in future.

What is claimed is:

1. An instruction receiving system comprising:
an arrangement determination portion configured to determine an arrangement of a display region on a display portion;
a display controlling portion configured to display a user interface screen on the display region; and
a pointer display portion configured to display a pointer on the display portion based on an output value of a pointing device, wherein
when the arrangement is changed, the pointer display portion determines a range of the display portion based on the arrangement changed, the range of the display portion corresponding to a range of the output value of the pointing device.

2. The instruction receiving system according to claim 1, wherein
the arrangement determination portion determines the arrangement of the display region on the display portion by choosing an option for the arrangement among at least one or more options.

3. The instruction receiving system according to claim 2, wherein:
the options for the arrangement to be determined by the arrangement determination portion include
a first arrangement in which a whole width of the display portion serves as a width of the display region, and
a second arrangement in which a partial width of the display portion serves as the width of the display region;
in a case where the arrangement changed is the first arrangement, the pointer display portion associates the range of the output value with the whole width of the display portion; and
in a case where the arrangement changed is the second arrangement, the pointer display portion associates the range of the output value with the partial width of the display portion.

4. The instruction receiving system according to claim 2, wherein:
the options for the arrangement to be determined by the arrangement determination portion includes a third arrangement in which a first range within the width of the display portion serves as a width of a first display region and a second range different from the first range within the width of the display portion serves as a width of a second display region;
when the arrangement changed is the third arrangement and the pointer exists in the first display region, the pointer display portion associates the range of the output value with the first range; and
when the arrangement changed is the third arrangement and the pointer exists in the second display region, the pointer display portion associates the range of the output value with the second range.

5. An instruction receiving method comprising:
(a) determining an arrangement of a display region on a display portion;
(b) displaying a user interface screen on the display region; and
(c) displaying a pointer on the display portion based on an output value of a pointing device, wherein
in step (c), when the arrangement is changed, a range of the display portion based on the arrangement changed, the range of the display portion corresponding to a range of the output value of the pointing device.

6. A recording medium in which an instruction receiving program is stored and from which the instruction receiving program is readable by a computer, the instruction receiving program comprising:
an arrangement determination function to cause a computer to implement a function to determine an arrangement of a display region on a display portion;
a display controlling function to cause the computer to implement a function to display a user interface screen on the display region;
a pointer display function to cause the computer to implement a function to display a pointer on the display portion based on an output value of a pointing device, wherein
when the arrangement is changed, the pointer display function causes the computer to implement a function to determine a range of the display portion based on the arrangement thus changed, the range of the display portion corresponding to a range of the output value of the pointing device.
